(19) United States
(12) Patent Application Publication
(10) Pub. No.: US 2014/0076954 A1
(43) Pub. Date: Mar. 20, 2014

(54) PALLET NAIL CLINCHING APPARATUS AND METHODS

(71) Applicant: STANLEY FASTENING SYSTEMS, L.P., North Kingstown, RI (US)

(72) Inventors: Keven E. Miller, Wyoming, RI (US); Jonathan W. Fairbanks, Coventry, RI (US); Richard Waterman, North Kingstown, RI (US); Jared Rondeau, Dayville, CT (US); Paul M. Jacey, Noank, CT (US)

(21) Appl. No.: 13/836,350

(22) Filed: Mar. 15, 2013

Related U.S. Application Data
(60) Provisional application No. 61/702,526, filed on Sep. 18, 2012.

(51) Int. Cl. B25C 7/00; B25C 1/00

(52) U.S. Cl. CPC B25C 7/00; B25C 1/00
USPC 227/155; 29/432.1

(57) ABSTRACT

An apparatus and methods for clinching nails into workpieces are provided. The apparatus can include a housing assembly including a driving assembly capable of driving a fastener. A nose piece can be arranged with the housing assembly and can define a fastener drive track. A clinching assembly can be arranged with the housing assembly and can include a movable anvil including an anvil tip portion. The movable anvil is capable of being moved into a position whereby the workpieces are held between the anvil tip portion and the nosepiece, while the anvil tip portion is operable to bend a fastener tip into one of the workpieces after being driven through the workpieces.

### CROSS REFERENCE TO RELATED APPLICATION

The present application claims the benefit from earlier filed U.S. Provisional Patent Application No. 61/702,526 filed Sep. 18, 2012, which is incorporated herein in its entirety by reference.

### FIELD OF THE INVENTION

The present teachings relate generally to the field of pallet fastening tools. In particular, the present teachings relate to an apparatus and method for manufacturing and repairing pallets used in the shipping and handling of commercial of goods.

### BACKGROUND OF THE INVENTION

Pallets are constructed by assembling wood boards in the form of a frame having at least one, and normally two, supporting surfaces or platforms which are spaced by beams or stringers that extend perpendicular to the supporting surfaces in spaced relation. While most pallets are wooden, pallets can also be made of plastic, metal, and paper. In the manufacture of wooden pallets, the boards which form the supporting surfaces at both the top and bottom of the pallet are spaced at desired intervals along such surface and fastened to the beams or stringers to form a rigid frame assembly.

Pallets include, but are not limited to, stringer pallets that use a frame of three or more parallel pieces of timber (i.e., stringers) wherein top deck boards are then affixed to the stringers to create the pallet structure. Block pallets use both parallel and perpendicular stringers and the top deck boards are supported by blocks of wood.

Pallets can undergo repair to fix damage that occurs during the shipping and handling process. As a result, during the life of a pallet, it may be repaired numerous times. In pallet construction, heat-treated screws are often used to join together workpieces (e.g. boards), such as the connection between deck boards and blocks or stringers. As such, during the repair of pallets, heat-treated screws are difficult to remove and must be cut off, resulting in damaged repair tool blades. The installation of screws can also be a relatively time-consuming process in comparison to nailing. Moreover, the integrity of a screw joint is much more sensitive to the material in which it is made in comparison to a clinched nail joint.

Accordingly, there generally exists a need for an apparatus and method that uses regular or clinch nails to fasten pieces of a pallet together in a clinched manner to provide the same or greater strength than that provided by screws. There also exists a need for such an apparatus and method that uses regular or clinch nails to secure both the edges and the center portions of the pallet, or to secure any other location on the pallet.

### SUMMARY OF THE INVENTION

The present teachings provide an apparatus for clinching nails into workpieces. The apparatus can include a housing assembly including a driving assembly capable of driving a fastener and a nose piece arranged with the housing assembly and defining a fastener drive track. A clinching assembly can be arranged with the housing assembly and can include a movable anvil including an anvil tip portion. The movable anvil can be capable of being moved into a position whereby the workpieces are held between the anvil tip portion and the nosepiece, while the anvil tip portion is operable to bend a fastener tip into one of the workpieces after being driven through the workpieces.

The present teachings provide a further embodiment of an apparatus for clinching nails into workpieces. The further embodiment can include a clinch surface member including a first edge ramp at a first end thereof and a bottom flange member capable of being secured to a fixed station. A web flange member can be arranged between the clinch surface member and the bottom flange member. The clinch surface member and the web flange member can be configured such that a top stringer of a pallet is capable of being slid over the first edge ramp and rested on the clinch surface member, while a bottom stringer of the pallet is supported between the clinch surface member and the bottom flange member.

The present teachings provide a still further embodiment of an apparatus for clinching nails into workpieces. The still further embodiment can include an arm including a proximal end and a distal end. A handle can be arranged on the proximal end of the arm and an expandable clinching head can be arranged on the distal end of the arm. The expandable clinching head can include at least one displaceable clinching plate. The at least one displaceable clinching plate can be capable of deflecting a tip of a fastener away from the expandable clinching plate head when the fastener is driven into the clinching plate.

Additional features and advantages of various embodiments will be set forth, in part, in the description that follows, and will, in part, be apparent from the description, or may be learned by the practice of various embodiments. The objectives and other advantages of various embodiments will be realized and attained by means of the elements and combinations particularly pointed out in the description herein.

### BRIEF DESCRIPTION OF THE DRAWINGS

FIG. 1 is a perspective view of a pallet including edge and center stringers;

FIG. 2A shows a side view of a pallet nail clinching apparatus according to an embodiment of the present teachings;

FIG. 2B shows a front view of the pallet nail clinching apparatus of FIG. 2A;

FIG. 3 shows the pallet nail clinching apparatus of FIG. 2A in an operating position on the pallet;

FIG. 4 shows a close-up side view of the pallet nail clinching apparatus of FIG. 2A about to engage in a clinching operation;

FIG. 5 shows a side view of the pallet nail clinching apparatus of FIG. 2A clinching a fastener between workpieces;

FIG. 6 shows the pallet nail clinching apparatus of FIG. 2A clinching a fastener to a center stringer of a pallet;

FIG. 7 shows a close-up view of FIG. 6;

FIG. 8 shows a close-up view from the underside of the pallet shown in FIGS. 6 and 7;

FIG. 9A shows a perspective view of a pallet nail clinching apparatus according to a still further embodiment of the present teachings;

FIG. 9B shows a side view of the pallet nail clinching apparatus of FIG. 9A secured to a fixed station;

FIG. 10A shows a side view of an array of pallet nail clinching apparatus of FIG. 9A with a conventional fastening tool in a position for clinching a fastener to a nailing site on a pallet;

FIG. 10B shows a perspective view of the array of pallet nail clinching apparatus of FIG. 9A arranged with the pallet in a position ready for fasteners to be clinched to the pallet;

FIG. 11A shows a side view of an array of pallet nail clinching apparatus of FIG. 9A with the pallet flipped over from the arrangement in FIGS. 10A and 10B;

FIG. 11B shows a perspective view of the array of pallet nail clinching apparatus of FIG. 9A arranged with the pallet flipped over from the arrangement in FIGS. 10A and 10B;

FIG. 12A shows a front view of a pallet nail clinching apparatus according to a yet another embodiment of the present teachings;

FIG. 12B shows a side view of the pallet nail clinching apparatus of FIG. 12A;

FIG. 13 shows a side view of the pallet nail clinching apparatus of FIG. 12A with the clinching plates in a retracted, expanded position; and

FIG. 14 shows the pallet nail clinching apparatus of FIG. 12A in a position for clinching a fastener.

It is to be understood that both the foregoing general description and the following detailed description are exemplary and explanatory only, and are intended to provide an explanation of various embodiments of the present teachings.

### DETAILED DESCRIPTION OF THE PREFERRED EMBODIMENTS

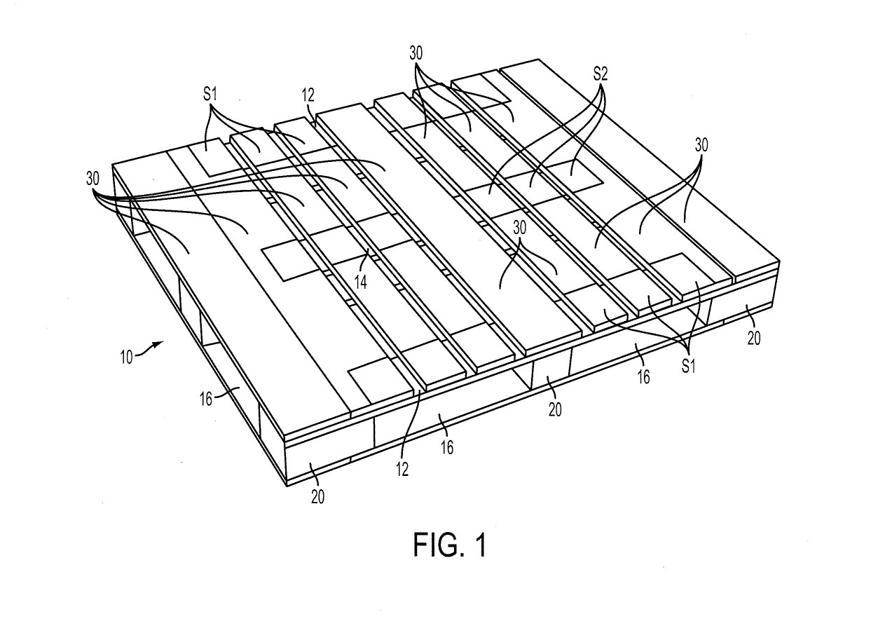

Referring to FIG. 1, an example of a block pallet 10 is shown. A top portion of the block pallet 10 can include several stringers, such as edge stringers 12 and a center stringer 14. A bottom portion of the block pallet 10 can also include several stringers 16. The stringers 12, 14, 16 can extend parallel or perpendicularly to each other. The top and bottom stringers 12, 14, 16 can be secured to a plurality of blocks 20 arranged at the corners, center, and ends of the pallet 10 to form a base thereof. While a single central stringer 14 is shown in FIG. 1, a block pallet 10 can include more than one central stringer 14.

FIG. 1 shows several pallet fastening nail sites, S1 and S2, indicating areas where nails can be clinched so as to securely fasten top deck boards 30 to edge stringers 12 or to center stringers 14. The nail sites, S1, are disposed at the sides of the block pallet 10 along the length of the edge stringers 12 while the nail sites, S2, are disposed centrally through the block pallet 10 along the length of the central stringer 14. Although a block pallet 10 is shown in FIG. 1, the device and methods of the present teachings can be used to clinch nails for other designs of pallets, stringers, and any other workpieces forming structural joints that are required to be secured together.

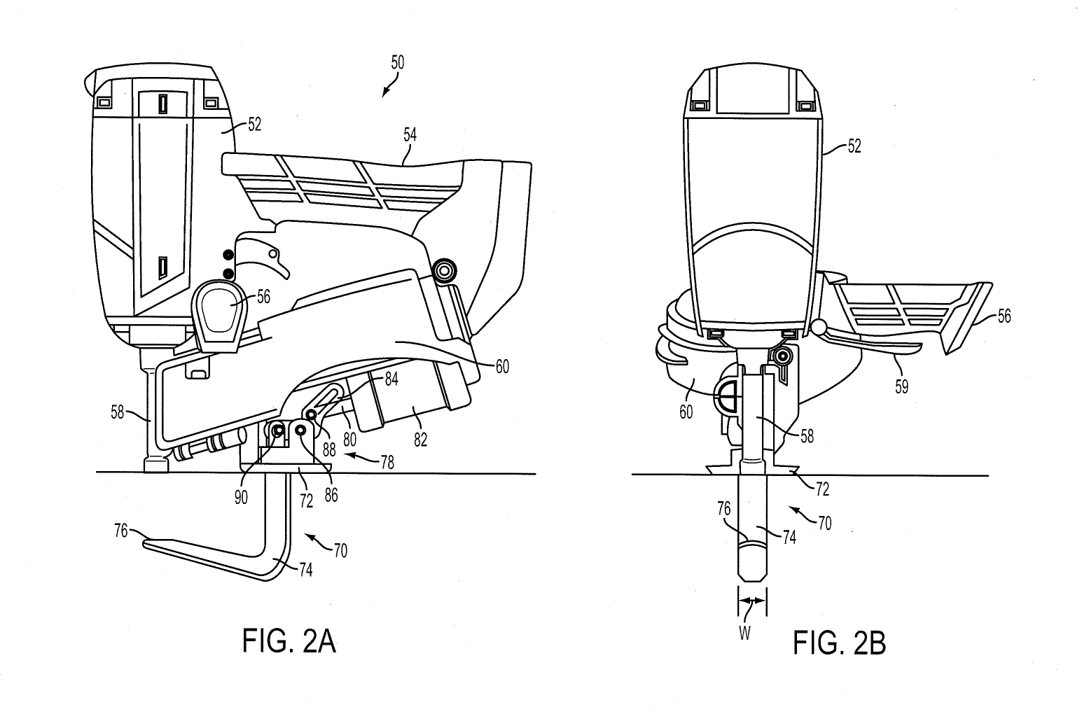

FIGS. 2A-2B illustrate an embodiment of a pallet nail clinching apparatus 50 of the present teachings.

The pallet nail clinching apparatus 50 can include a housing assembly 52. The housing assembly 52 can be constructed from a lightweight yet durable material, such as magnesium. The housing assembly 52 can include an engine receiving portion configured to contain an engine that is constructed and arranged to drive a fastener, F, into workpieces. The engine can be any suitable engine for driving the fastener into workpieces and that converts stored energy into kinetic energy to drive the fastener. For example, the engine can be a pneumatic-type engine that is powered by compressed air, or the engine can be powered by a battery, chemical reaction, etc., as is known in the art. Embodiments of the present teachings are not limited to any specific type of engine.

As shown in FIGS. 2A-2B, the pallet nail clinching apparatus 50 can be a pneumatically actuated fastening tool which embodies the principles of the present teachings. The housing assembly 52 can include a primary handle 54 and an auxiliary handle 56 each having a hollow configuration. The primary handle 54 and the auxiliary handle 56 can constitute reservoir chambers for supplying air under pressure coming from a source which is communicated therewith. The handle portions 54, 56 are adapted to be gripped by the hand of a user. The housing assembly 52 can further include a driving assembly (not shown) for driving a fastener into workpieces and can be arranged with a nose piece 58 defining a fastener drive track, which is adapted to laterally receive therein a leading fastener from a package of fasteners mounted within a fastener magazine 60. The fasteners can be arranged in a coil magazine as shown in FIGS. 2A and 2B. Alternatively, the fasteners can be arranged linearly in an elongated magazine or the like. The fastener magazine 60 can include a pusher for pushing fasteners from the coil to a delivery end of the pallet nail clinching apparatus 50 where the fasteners can be driven by the fastener driving element of the driving assembly and embedded into the workpieces.

The housing assembly 52 of the pallet nail clinching apparatus 50 can include a main body portion including a cylinder therein which has its upper end disposed in communicating relation with the reservoir chambers. A piston can be slidably and sealingly mounted in the cylinder for movement through repetitive cycles, each of which includes a drive stroke and a return stroke. The fastener driving element is operatively connected to the piston and is slidably mounted within the fastener drive track and movable by the piston through a drive stroke in response to the drive stroke of the piston, during which the fastener driving element engages a fastener within the drive track and moves the same longitudinally outwardly into the workpieces, and a return stroke in response to the return stroke of the piston.

The pallet nail clinching apparatus 50 of the present teachings includes a clinching assembly 70 that operates to bend a fastener tip of a fastener that has been driven by the fastener driving element. The clinching assembly 70 can operate to bend a tip of a fastener after it has been driven through workpieces, such as through a top deck board 30 and stringer 12, 14 of a pallet. The clinching assembly 70 can include a tool base 72 that contacts the top surface of the upper workpiece (e.g. a top deck board 30), an anvil 74 slidably mounted with the tool base 72, and a linkage assembly 78 pivotably mounted to the tool base 72. A tip portion 76 of the anvil 74 is slidably arranged adjacent to the nose piece 58 of the apparatus 50.

During operation, the anvil 74 is pulled toward the nose piece 58 by the linkage assembly 78 which is connected to an air cylinder assembly 82 including an air cylinder rod 80 and piston. The air cylinder assembly 82 can be activated by an auxiliary handle lever 59 situated arranged next to the auxiliary handle 56, such that when the auxiliary handle lever 59 is pulled, a valve in the auxiliary handle 56 is opened to supply air to the air cylinder assembly 82 and to the apparatus 50. Pressurized air supplied to the air cylinder assembly 82 moves the piston situated in the air cylinder assembly 82, and in turn, moves the air cylinder rod 80.

Referring to FIGS. 2A and 5, movement of the air cylinder rod 80 in the rightward direction causes a linkage member 84 to pivot about a pivot pin 86 arranged in the tool base 72, as a pivot link 88 is guided through an aperture formed in the linkage member 84. The pivoting movement of the linkage member 84 causes the anvil 74 to be pulled in an upward direction by way of an anvil pin 90 that pivotably connects the linkage member 84 with the anvil 74.

As shown in FIGS. 4 and 5, when the anvil 74 is pulled toward the nose piece 58 to close the space between the anvil 74 and the nose piece 58, the anvil 74 forcibly presses together the workpieces to be fastened (e.g. a top deck board 30 and stringer 12). The fastener, F, is then driven from the apparatus 50 by the fastener driving assembly through the each of the pressed-together workpieces so that the tip of the fastener strikes the tip portion 76 of the anvil 74 thereby further pressing the workpieces together and permanently securing them. The force of the fastener striking the tip portion 76 of the anvil 74 causes the fastener tip to bend away from the anvil tip portion 76 and toward the surface of the lowermost workpiece. The anvil 74 thus operates to bend the fastener so that the fastener is clinched and the workpieces are secured together as shown in FIG. 5.

When using clinch nails with the pallet nail clinching apparatus 50 of the present teachings, the anvil tip portion 76 can be arranged to have a substantially flat clamping surface. In use, the asymmetrical tip of a clinch nail would strike the flat surface of the anvil tip portion 76 and its geometry would cause the tip to bend away and back toward the lowermost workpiece.

When using regular nails with the pallet nail clinching apparatus 50 of the present teachings, the anvil tip portion 76 can be arranged to have an angled, curved, or beveled clamping surface. In use, the generally symmetrical tip of a regular nail would strike the non-flat surface of the anvil tip portion 76 which surface would cause the tip to bend away and back toward the lowermost workpiece.

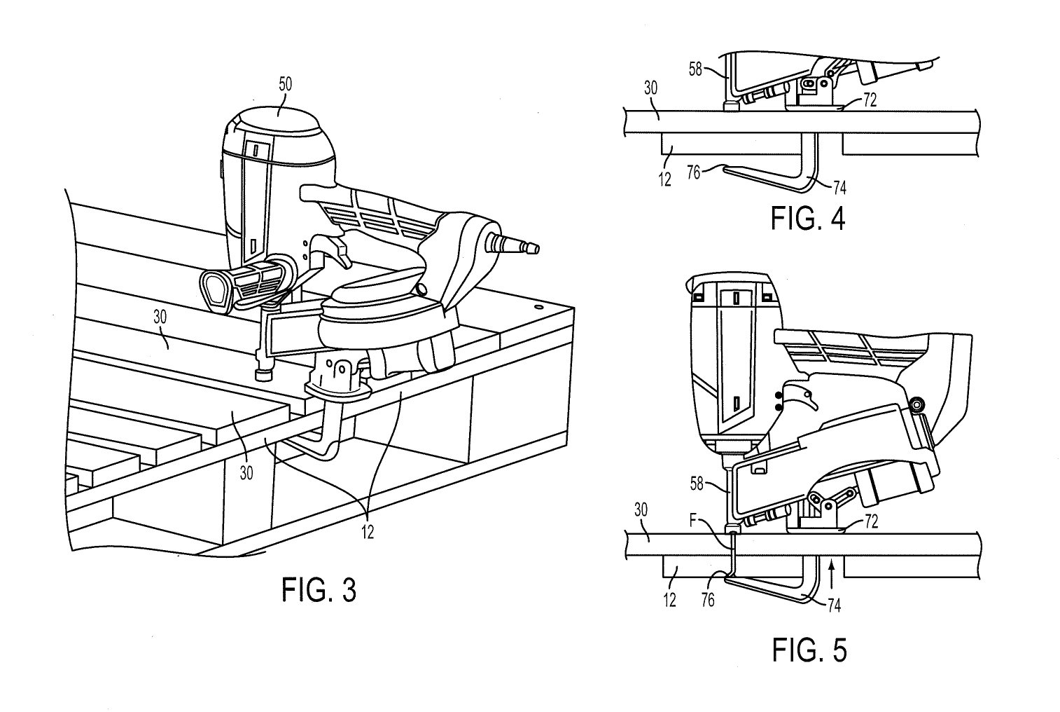

As shown in FIG. 3, the pallet nail clinching apparatus 50 can be positioned to clinch fasteners along an edge stringer 12. In particular, the pallet nail clinching apparatus 50 can be positioned to clinch a fastener after it has been driven through a top deck board 30 and an edge stringer 12.

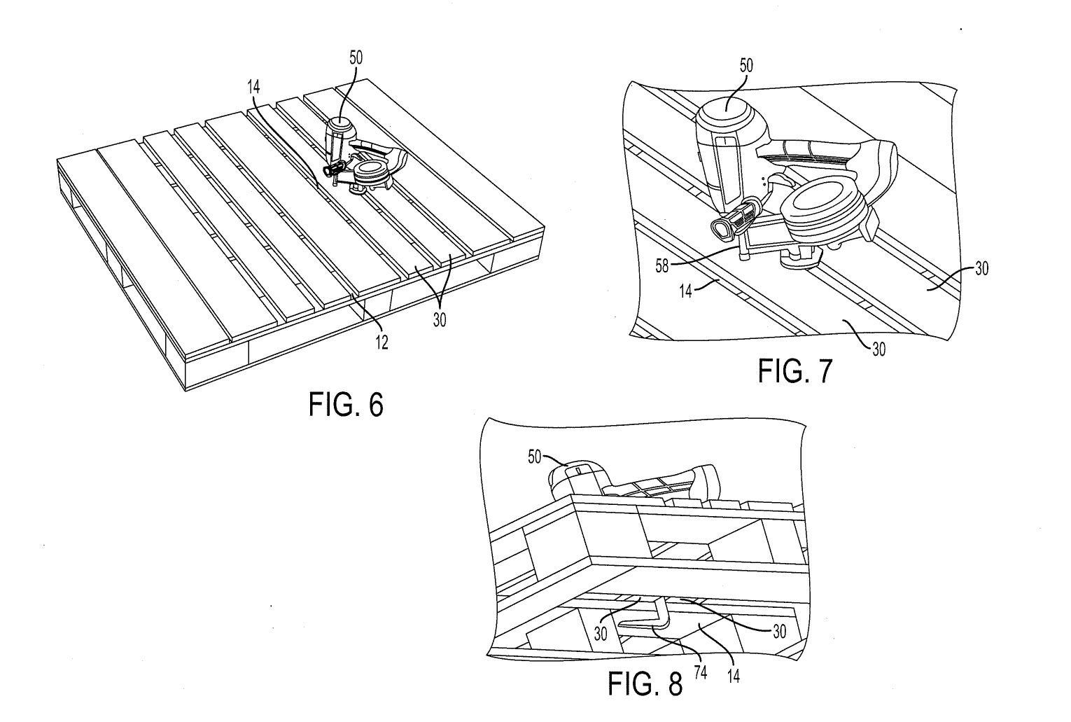

As shown in FIGS. 2A, 2B, 6, 7, and 8, the narrow or thin design of the anvil 74 of the present teachings allows the anvil 74 to be inserted within the space between two adjacent top deck boards 30. The pallet nail clinching apparatus 50 can then be used to secure top deck boards 30 to center stringers 14. As shown in FIG. 2B, the anvil 74 is shown having a width, W. As an example only, the anvil width, W, can be up to about 1 inch wide so as to fit between neighboring top boards 30. While the standard clearance distance between top boards 30 on a block pallet is about 1.08 inches, the invention is not limited to a specific clearance distance between top boards or a specific anvil width. Furthermore, referring to FIG. 2A, the distance from the end of the anvil tip portion 76 to the vertically extending portion of the anvil 74 (referred to as the ‘throat’) can be any distance to allow adequate spacing of nails when being clinched to the workpieces. The relatively narrow width, long throat, and general shape of the anvil 74 defines a structure that can generally extend in a plane.

As shown in FIGS. 7 and 8, after inserting the anvil 74 between two adjacent top deck boards 30, the pallet nail clinching apparatus 50 can be rotated so that the nose piece 58 of the apparatus 50 is positioned over an overlapping top deck board 30 and a center stringer 14 thereby allowing these workpieces to be clinched together.

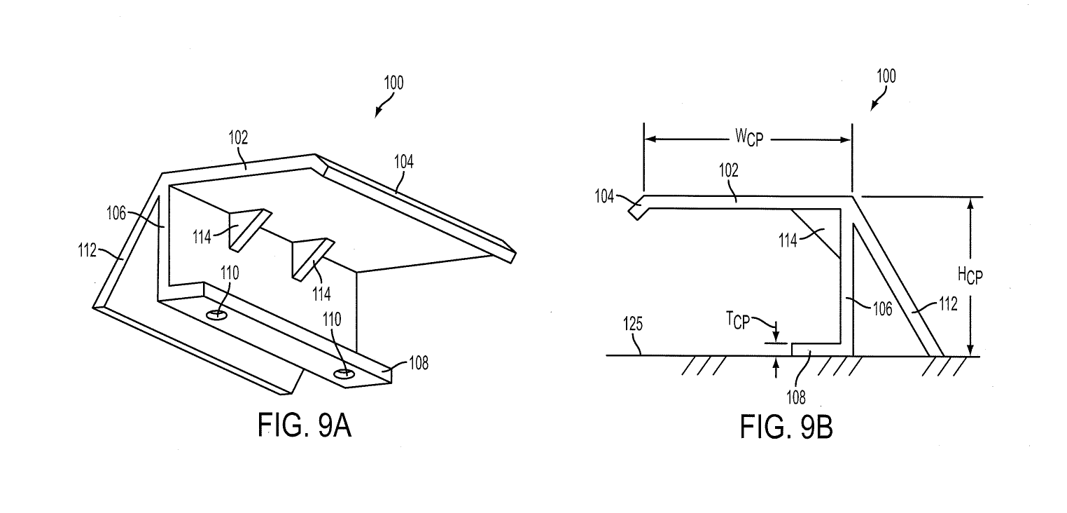

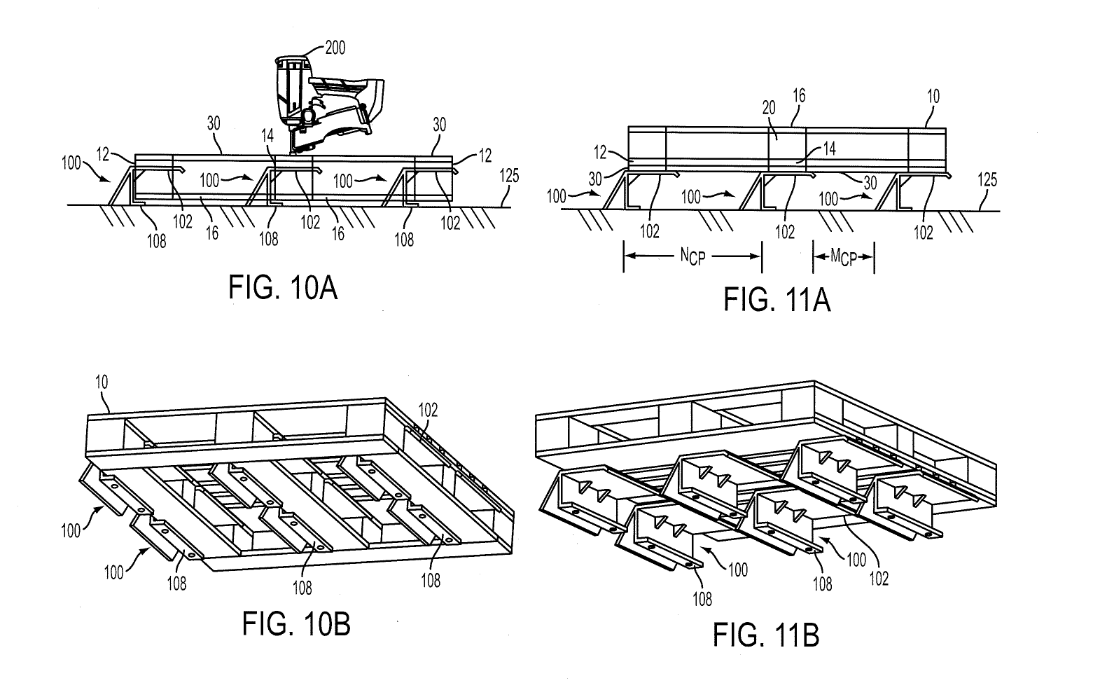

FIGS. 9A, 9B, 10A, and 10B show a further embodiment of a pallet nail clinching tool of the present teachings. The clinching tool can be in the form of a clinching plate 100 that can be mountable to a fixed station 125, such as a steel repair table or bench top. The clinching plate 100 can be mounted to a fixed station 125 by way of a bottom flange member 108 which can include one or more apertures 110 for receiving a fastener, such as a bolt or the like. One or more clinching plates 100 can be mounted in an array to a bench or table top 125 in any manner including, but not limited, bolting or welding.

As will be described in more detail below referring to FIG. 10A, a pallet needing repair 10 is picked up and placed on one or more clinching plates 100 that are arranged in an array. The pallet 100 is placed in a position where a clinch surface member 102 of each respective clinching plate 100 can be used to bend the tip of a driven fastener away from the clinching plate 100 and toward the workpieces 12, 14, 30 of the pallet to be repaired. Bending the tip of the fastener secures or clinches the fastener in place on the workpieces.

Referring to FIGS. 9A and 9B, the clinch surface member 102 on a top portion of the clinching plate 100 includes an edge ramp 104 at one end thereof. The clinching plate 100 can also include a web flange member 106 that can be arranged to support the clinch surface member 102 a set distance from the bottom flange member 108. Moreover, one or more gussets 114 can be arranged to reinforce the connection between the web flange member 106 and the clinch surface member 102. An additional edge ramp 112 can be arranged to extend at an angle and downwardly from an opposite side of the clinch surface member 102.

The components of the clinching plate 100 can be made from any strong, rigid material capable of bending a nail fastener, such as steel plate, which can be welded together. However, one of ordinary skill in the art would appreciate that other engineering materials can be used to make the clinching plate 100 of the present teachings, such as carbon fiber composite, aluminum, metal-composite structures, and the like.

Referring to FIG. 9B, the general dimensions of the clinching plate 100 will be discussed. The thickness, T_{CP}, of the components making up the clinching plate 100 can be any dimension that provides structural strength, such as a thickness from about 0.20 inches to about 0.30 inches. The width, W_{CP}, of the clinch surface member 102 can be from about 5.5 inches to about 7 inches, and preferably about 6.25 inches. The height, H_{CP}, of the clinching plate 100 can be at least about 5.0 inches.

As shown in FIGS. 10A and 10B, a plurality of clinching plates 100 can be arranged on the bench top 125 in an array that matches the configuration of the support portions of a pallet 10. In particular, the clinching plates 100 can be arranged in an array whereby each clinch surface member 102 can be situated under the respective pallet fastening nail sites, S1 and S2, of the pallet 10 where nails can be used to clinch a top deck board 30 to an edge stringer 12 or a center stringer 14. A typical array could include three rows of clinching plates 100 with each row including two clinching plates 100, as shown in FIGS. 10A and 10B. However, the array could include any number of rows and any number of clinching plates 100 arranged in each row.

As best shown in FIG. 11A, for a standard pallet 10, the distance, N_{CP}, between neighboring web flange members 108 can be from about 165 inches to about 18.5 inches, and preferably about 17.5 inches. Similarly, the distance, M_{CP}, from the end of an edge ramp 104 of a first clinching plate 100 and the end of an edge ramp 112 of a neighboring second clinching plate 100 can be from about 9.5 inches to about 11.5 inches, and preferably about 10.5 inches.

The positioning of the clinching plates 100 in such an array allows the pallet 10 that is to be repaired (or newly built) to fit over and in-between the clinching plates 100 and then to be slidingly arranged into a position whereby an edge stringer 12 or a center stringer 14 rests on respective clinch surface member 102. In this regard, the beveled edge ramps 104, 112 on either side of the clinch surface members 102 facilitate sliding movement of the pallet 10 onto the striking surfaces of the clinching plates 100, as well as the removal of the pallet 10. In the position shown in FIG. 10A, the clinch surface members 102 of the clinching plates 100 are arranged between the top deck boards 30 and the bottom stringers 16 and support the pallet 10 using the stringers 12, 14.

Once the pallet 10 that is to be repaired is supported by the clinching plates 100, a conventional fastening tool 200, such as a nailer, can be used to drive a fastener into the arranged workpieces (e.g. top deck board 30 and center stringer 14). The conventional fastening tool 200 can drive the fastener through the arranged workpieces so the tip of the fastener strikes the surface of the clinch surface member 102. The force of the fastener striking the clinch surface member 102 causes the fastener tip to bend away from the clinch surface member 102 and toward the surface of the lowermost workpiece. The clinch surface member 102 thus operates to bend the fastener so that the fastener is clinched and the workpieces are secured together.

As shown in FIGS. 11A and 11B, the pallet 10 can be flipped over and set on top of the clinching plates 100 such that the clinching plates 100 are arranged outside (i.e. completely below) the pallet 10 to be repaired. In this position, the top deck boards 30 rest on the clinch surface members 102 of the clinch plates 100. The conventional fastening tool 200 can then be used to drive a fastener through the bottom stringers 16 and into respective blocks 20.

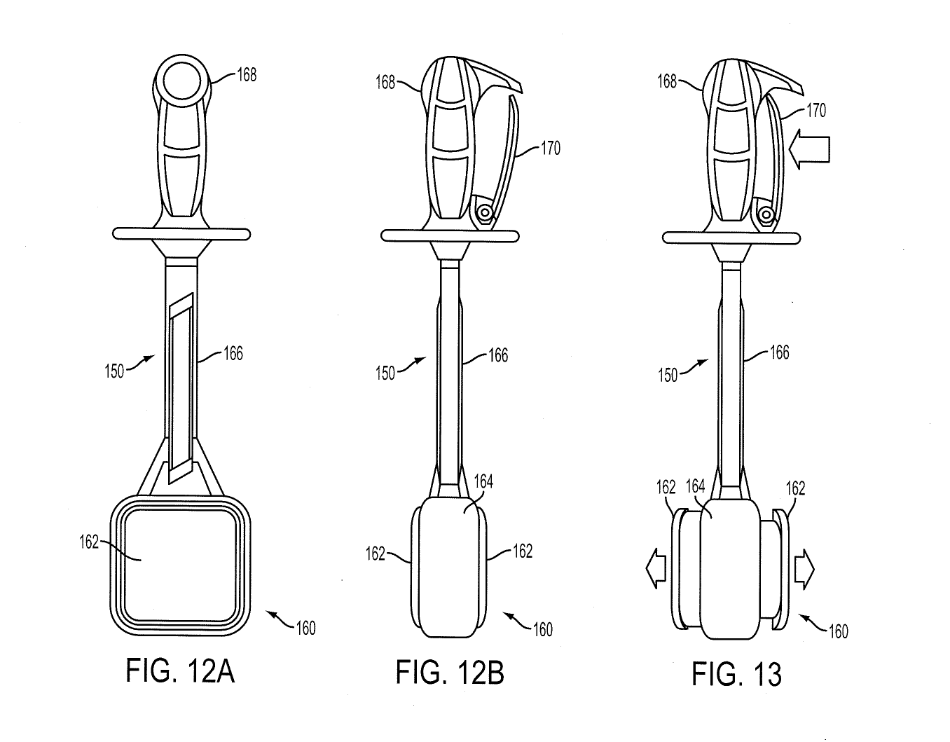

A still further embodiment of a pallet nail clinching apparatus of the present teachings is shown in FIGS. 12A, 12B, and 13. The clinching tool 150 can include an expandable clinching head 160 that includes at least one displaceable clinching plate 162 that can be used to bend the tip of a driven fastener away from the clinching plate 162 and toward the workpieces to be fastened, as will be described in more detail below.

The clinching tool 150 can include an extension aim 166 with a handle 168 arranged at a proximal end thereof and a displaceable clinching plate head 160 arranged at the distal end thereof. The displaceable clinching plate head 160 can include at least one displaceable clinching plate 162 which is mounted on an expandable air chamber or cylinder 164. However, the expandable air chamber or cylinder 164 can be substituted with any user actuable mechanism that can operate to displace and retract the at least one displaceable clinching plate 162, such as a hydraulic, electric or mechanical mechanism

The handle 168 can include an activating lever 170 pivotably mounted thereto. When the activating lever 170 is pressed as shown in FIG. 13, a valve can be opened that introduces air into the expandable air chamber 164. Air entering into the expandable air chamber 164 causes the chamber to expand thereby causing the one or more displaceable clinching plates 162 to move outwardly. Conversely, the one or more displaceable clinching plates 162 can be arranged to retract when air is released from the expandable air chamber 164.

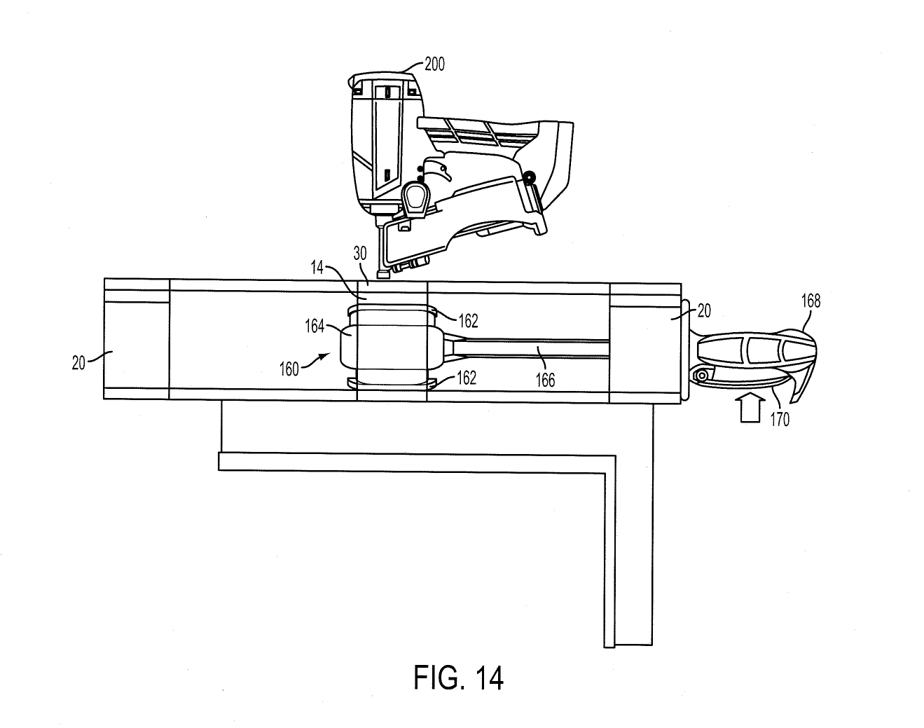

The arm 166 and handle 168 can be sized and/or be made extendable to allow the clinching plate head 160 to reach both the edge stringers 12 and the center stringer 14 of a pallet 10 when positioning the clinching plate head 160, as shown in FIG. 14. This allows the clinching plate head 160 to reach all of the pallet fastening nail sites, S1 and S2, of the pallet 10 of FIG. 1.

In operation, a user holds the handle 168 of the clinching tool 150 and positions the clinching plate head 160 underneath the desired pallet fastening nail site, S1 and S2, where the fastener is desired to be driven. After pressing the activating lever 170, air can enter the expandable air cylinder 164 through the extension arm 166 causing the air cylinder 164 to expand to the inner dimension of the pallet space, such as the dimension of the block 20 shown in FIG. 14.

A conventional fastening tool 200, such as a nailer, can then be used to drive a fastener into the arranged workpieces (e.g. top deck board 30 and center stringer 14) at the desired pallet fastening nail site, S1 and S2. The conventional fastening tool 200 can drive the fastener through the arranged workpieces so the tip of the fastener strikes the surface of the displaceable clinching plate 162. The force of the fastener striking the displaceable clinching plate 162 causes the fastener tip to bend away from the displaceable clinching plate 162 and toward the surface of the lowermost workpiece. The displaceable clinching plate 162 thus operates to bend the fastener so that the fastener is clinched and the workpieces are secured together. The deflection of the tip by the displaceable clinching plate 162 bends the tip to clinch the fastener onto the workpieces while also further pressing the workpieces together.

The displaceable clinching plates 162 can be made from any strong, rigid material capable of bending a nail fastener, such as steel. However, one of ordinary skill in the art would appreciate that other engineering materials can be used to make the clinching plates 162 of the present teachings, such as carbon fiber composite, aluminum, metal-composite structures, and the like.

Clinched nails that are deflected and bent toward the workpieces produce a stronger fastening joint than traditional straight-input nails or screws. The pallet nail clinching apparatus and methods of the present teachings allows a user to use clinch nails, regular nails, or other non-heat treated nails to fasten top deck boards to stringers. As such, screws, which are generally heat-treated and therefore hardened, do not have to be used in pallet construction and repair. Moreover, non-heat treated nails that can be used with the pallet nail clinching apparatus of the present teachings are softer, and thereby easier to cut during the repair of pallets. Accordingly, the repair time needed for a particular pallet can be significantly reduced using the pallet nail clinching apparatus of the present teachings.

The present teachings have a number of advantages, including but not limited to, reducing the time of construction of a new pallet and the repair cycle for a damaged pallet. The ability to clinch the top board to a stringer along any edge and center stringers results in a reduced cost associated with construction and repair of pallets, for example.

While aspects of the present invention are described herein and illustrated in the accompanying drawings in the context of a fastening tool, those of ordinary skill in the art will appreciate that the invention, in its broadest aspects, has further applicability.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed is:

1. An apparatus for clinching nails into workpieces comprising:
a housing assembly including a driving assembly capable of driving a fastener;
a nose piece arranged with the housing assembly and defining a fastener drive track;
a clinching assembly arranged with the housing assembly and including a movable anvil including an anvil tip portion;
wherein the movable anvil is capable of being moved into a position whereby the workpieces are held between the anvil tip portion and the nosepiece while the anvil tip portion is operable to bend a fastener tip into one of the workpieces after being driven through the workpieces.

2. The apparatus of claim 1, wherein the driving assembly is driven by a pneumatic-type engine.

3. The apparatus of claim 1, wherein the movable anvil is displaceable by a linkage assembly.

4. The apparatus of claim 3, wherein the linkage assembly is operatively arranged with an air cylinder assembly.

5. The apparatus of claim 4, wherein the air cylinder assembly is activated by a lever and a valve in communication with an air supply.

6. The apparatus of claim 1, wherein the movable anvil extends substantially in a plane and is configured to fit within a gap formed between top deck boards of a standard pallet.

7. The apparatus of claim 1, wherein the movable anvil has a maximum width of about 1 inch.

8. The apparatus of claim 1, wherein the workpieces include a top deck board and a stringer.

9. The apparatus of claim 1, wherein the clinching assembly further includes a tool base and a linkage member pivotably arranged with the tool base.

10. The apparatus of claim 9, wherein the linkage member is operatively arranged with the anvil and with an air cylinder assembly.

11. An apparatus for clinching nails into workpieces comprising:
a clinch surface member including a first edge ramp at a first end thereof;
a bottom flange member capable of being secured to a fixed station; and
a web flange member arranged between the clinch surface member and the bottom flange member;
wherein the clinch surface member and the web flange member are configured such that a top stringer of a pallet is capable of being slid over the first edge ramp and rested on the clinch surface member while a bottom stringer of the pallet is supported between the clinch surface member and the bottom flange member.

12. The apparatus of claim 11, wherein the clinch surface member extends substantially parallel with respect to the bottom flange member.

13. The apparatus of claim 11, wherein the clinch surface member includes a second edge ramp at the second end thereof.

14. The apparatus of claim 11, wherein the web flange member is arranged with the clinch surface member at a second end of the clinch surface member.

15. The apparatus of claim 11, wherein the clinch surface member is made of steel plate.

16. The apparatus of claim 11, further comprising at least one gusset arranged between the clinch surface member and the web flange member.

17. An array including at least two of the apparatus of claim 11 arranged in at least two rows on a fixed station, whereby a first top stringer of a pallet is capable of being slid over an edge ramp and rested on a first clinch surface member and a corresponding first bottom stringer of the pallet is supported between the first clinch surface member and a first bottom flange member, while simultaneously a second top stringer of the pallet is capable of being slid over an edge ramp and rested on a second clinch surface member and a second bottom stringer of the pallet is supported between the second clinch surface member and a second bottom flange member.

18. The array of claim 17, further including three rows of the apparatus arranged such that a center stringer of the pallet is capable of being rested on a clinch surface member.

19. A method of clinching a nail into workpieces comprising:
securing at least one of the apparatus of claim 11 to a fixed station;
sliding a top stringer of a pallet over the first edge ramp and resting the top stringer on the clinch surface member while supporting a bottom stringer of the pallet between the clinch surface member and the bottom flange member; and
driving a fastener through the top stringer into the clinch surface member and bending the tip of the fastener away from the clinching plate and back toward the top stringer.

20. An apparatus for clinching nails into workpieces comprising:
an arm including a proximal end and a distal end;
a handle arranged on the proximal end of the arm;
an expandable clinching head arranged on the distal end of the arm, the expandable clinching head including at least one displaceable clinching plate;
wherein the at least one displaceable clinching plate is capable of deflecting a tip of a fastener away from the expandable clinching plate head when the fastener is driven into the clinching plate.

21. The apparatus of claim 20, wherein the at least one displaceable clinching plate is arranged with an expandable air chamber.

22. The apparatus of claim 21, further comprising a user actuable valve capable of communicating a source of air to the expandable air chamber.

23. The apparatus of claim 22, wherein the user actuable valve communicates the source of air to the expandable air chamber through the arm.

24. The apparatus of claim 21, wherein the expandable clinching head includes two oppositely arranged displaceable clinching plates.

25. The apparatus of claim 20, wherein the arm is extendable.

26. A method of clinching nails into workpieces comprising:
placing the expandable clinching head of the apparatus of claim 20 at a pallet fastening site situated between the stringers of a pallet;
expanding the expandable clinching head until the at least one displaceable clinching plate is forced against a stringer; and
driving a fastener through the stringer into the clinching plate and bending the tip of the fastener away from the clinching plate and back toward the stringer.
